(19) United States
(12) Patent Application Publication
(10) Pub. No.: US 2010/0313442 A1
(43) Pub. Date: Dec. 16, 2010

(54) METHOD OF USING SYNGAS COOLING TO HEAT DRYING GAS FOR A DRY FEED SYSTEM

(76) Inventors: Steven Craig Russell, Houston, TX (US); Judeth Brannon Corry, Manvel, TX (US); Geroge Frederick Frey, Houston, TX (US); Sunil Ramabhilakh Mishra, Houston, TX (US); Omprakash Mall, Bhubaneswar Orissa (IN)

Correspondence Address: NIXON & VANDERHYE P.C., 901 NORTH GLEBE ROAD, 11TH FLOOR, ARLINGTON, VA, 22203, US

(21) Appl. No.: 12/483,314

(22) Filed: Jun. 12, 2009

(51) Int. Cl. F26B 3/02; F26B 21/14; F26B 23/02; B02C 23/18; F28D 3/00

(52) U.S. Cl. 34/468; 34/493; 34/513; 34/79; 34/201; 241/17; 241/65; 165/157

(57) ABSTRACT

A method for improving the overall thermal efficiency of a coal power generation plant by transferring heat from a raw synthesis gas stream to solid fuel used as the primary feed to the gasifier, comprising the steps of initially cooling the syngas exhaust by transferring heat to a makeup conveyance gas feed to the dry feed preparation system, feeding a solid fuel component and a portion of the makeup gas stream into a grinding mechanism for the solid feedstock, forming a two-phase solids/gas stream comprising ground feedstock particulates and makeup gas, heating and drying the ground solid feedstock particulates to remove water, separating and removing water vapor formed in the heating and drying step, and feeding the heated and dried solids/gas stream to the gasifier.

### BACKGROUND OF THE INVENTION

The present invention relates to a method for improving the overall efficiency of coal power generation plants by transferring heat from a synthesis gas stream to solid fuel used as the primary feed to the combustors of a gas turbine engine.

The gasification of solid feedstocks and subsequent combustion of hydrocarbon components from the feedstock in a gas turbine engine are known. In the case of coal used as the feedstock, most gasification processes require relatively dry (low moisture content) coal because of the difficulties in conveying moist solids and the inherent efficiency losses associated with moisture present in the coal feedstock. Since almost all commercially available coals contain a certain amount of water, the need exists to dry the coal in an efficient manner prior to gasification. That need becomes even more important when using sub-bituminous, lignite or brown coal feedstocks that often contain between about 20% and about 65% by weight water.

A known method of drying solids fuel feedstocks to gasifiers involves sweeping very hot gas through a solids grinding mill. In such systems, the drying gas temperature must be maintained well above the boiling temperature of water at the system operating pressure, normally between 300° F. and 900° F., in order to efficiently evaporate the excess moisture. Various means have been used in the past to create a drying gas medium that can be used to remove excess water in solids coal feedstocks. However, the known sources of heating and drying solids feedstocks have drawbacks that invariably reduce overall plant efficiency. For example, many systems include superheated steam and gas turbine extraction air utilized in heat exchangers, or fuel such as natural gas or propane in direct fired or indirect fired heat exchangers. In a direct fired configuration, hot combustion gas is generated using mixtures of air and the fuel component. Since natural gas or propane is an auxiliary stream that normally may not be present on-site. The direct firing of those fuels creates a pollutant emissions source and thus they often are not an acceptable method to economically dry a solids feedstock. Other prior methods use process steam or heated gases from a separate power plant in an indirect fired heat exchanger. Again, the need for separate power plant facilities to provide the necessary heat engine often is not an economical alternative.

Another known method of drying solids involves burning a portion of the clean synthesis gas produced through gasification and pass combustion gases over the milled coal as it is transported into a powder bunker or hopper. Milling and drying plants can reduce the overall efficiency of the power generating plant because they consume part of the gaseous fuel. Another prior method obtains drying energy by burning a portion of the milled coal, thereby heating the feed circulating in the drying plant. However, the net efficiency of the power generating plant necessarily decreases. In addition, emissions such as sulfur from the power plant increase when making drying energy available in that manner. Thus, while various conventional methods exist for drying coal feedstocks, a significant need still exists to reduce the inherent thermal inefficiencies in known processes.

### BRIEF DESCRIPTION OF THE INVENTION

The present invention comprises a method for improving the overall thermal efficiency of a coal power generation plant by transferring heat from a synthesis gas stream to solid fuel used as the primary feed to the gasifier. An exemplary embodiment includes the steps of initially cooling the raw syngas exhaust by transferring heat to a makeup gas feed to the feed preparation equipment, simultaneously feeding a solid fuel component (e.g., sub-bituminous coal) along with a portion of a conveyance/drying gas stream (e.g., inert gas) into a grinding mechanism (e.g., grinding mill) for the solid feedstock, forming a two-phase solids/gas stream comprising ground feedstock particulates and conveyance/drying gas, simultaneously heating and drying the ground solid feedstock particulates to remove water and increase the feedstock temperature, separating and removing substantially all of the water vapor formed in the heating and drying step, and feeding the heated and dried solids stream to the gasifier. The invention also contemplates a new syngas cooler design for transferring heat to the makeup gas stream used in the process and a related system using the various new syngas cooler designs.

### BRIEF DESCRIPTION OF THE DRAWINGS

FIG. 1 is an exemplary process flow diagram of a first embodiment of the process according to the invention whereby the cooling of hot syngas serves as the principal means to heat and dry the solids feedstock to a gasifier;

FIG. 2 is an exemplary process flow diagram of a second embodiment of the process according to the invention, again using the heat removed from the hot syngas as a principal means to dry a solids coal feedstock;

FIG. 3 is an exemplary process flow diagram of a third embodiment of the process according to the invention using syngas cooling as generally described in the first two embodiments;

FIG. 4 is an exemplary process flow diagram of a fourth embodiment of the process according to the invention also using syngas cooling as generally reflected in the first three embodiments;

FIG. 5A shows an exemplary syngas cooler (heat exchanger) used in the process according to the invention for heating the gas stream used in order to dry the solids feed to the gasifier, in this instance a syngas cooler having a continuous, vertically oriented coil disposed in an annular space between the interior wall and vessel shell;

FIG. 5B provides a front elevation view of the continuous, vertically oriented coil disposed in the annular space defined by the interior wall and vessel shell of the embodiment of FIG. 5A;

FIG. 6A depicts an alternative exemplary syngas cooler design as part of the process according to the invention using a continuous horizontally oriented coil disposed in the annular space between the interior wall and vessel shell;

FIG. 6B provides a front elevation view of the continuous, horizontally disposed coil in the annular space between the interior wall and vessel shell of the embodiment of FIG. 6A;

FIG. 7 depicts another alternative exemplary syngas cooler design according to the invention having a continuous, horizontally oriented heating coil located in the lower portion of the syngas cooler shell housing high temperature quench water during normal operation;

FIG. 8 shows a fourth alternative exemplary syngas cooler design as part of the process according to the invention, this time using a continuous, horizontally oriented coil disposed on opposite sides of a conical section of a quench wall located in the lower section of the syngas cooler;

FIG. 9 shows a fifth alternative exemplary syngas cooler design as part of the process according to the invention using a continuous, horizontally oriented coil disposed inside the inner cool shell wall described below (sometimes referred to as the cooler “dip tube”),

FIG. 10 depicts an exemplary process flow diagram of another alternative embodiment process according to the invention whereby a separate makeup gas stream similar to that used in the first, second and third embodiments is pre-heated using high temperature water before the makeup gas is introduced into the grinding mechanism (e.g., grinding mill);

FIG. 11 shows an exemplary flow diagram similar to FIG. 10 with an alternative flow configuration for pre-heating a separate part of the makeup gas using syngas cooling before the makeup gas is introduced into the grinding mechanism;

FIG. 12 depicts an exemplary flow diagram similar to FIG. 10, but with a second alternative flow configuration for pre-heating the separate makeup gas using syngas cooling before the makeup gas is introduced into the grinding mechanism; and

FIG. 13 shows an exemplary flow diagram similar to FIG. 10 but with a third flow configuration for pre-heating the separate makeup gas using syngas cooling before the makeup gas is introduced into the grinding mechanism.

### DETAILED DESCRIPTION OF THE INVENTION

As noted above, the present invention provides an improved method for using heated gas streams as the principal drying medium for solids feeds to a gasifier, particularly a sub-bituminous coal feedstock. The method integrates electrical power generation or chemical synthesis with a unique process for transferring heat to the coal feedstocks using synthesis gas cooling as the primary heat source and drying medium. Various levels of heat are available when syngas is cooled following incomplete combustion in a gasifier and thus the invention includes thirteen different embodiments capable of using all or portions of the heat transferred from the syngas in order to impart heat energy to a solids feed drying gas.

The present invention also takes advantage of an available heat source to dry ground solids that might otherwise not be used effectively, and thus offers a thermally efficient and lower cost method for generating power. Drying the feedstock to remove surface moisture imparts free flowing properties that improve the overall thermal efficiency of the power generation plant. The amount of heat required to release unwanted moisture in the feedstock in accordance with the invention depends on the process steps involved as well as the specific feed composition, but generally falls in the range of 1000-1500 btu/lbm of moisture evaporated. The temperature of the required heat source also typically ranges from 300-900° F. depending on the specific heat duty, the residence time in the drying step and the amount of recycled gas being used.

By way of summary, the various different embodiments of the invention described below all result in significantly improved use of heat available in the raw syngas produced during an initial gasification of a solid feedstock. The first embodiment defines the basic process steps and equipment used to integrate sensible heat from hot raw syngas into the feed system to dry incoming moist fuel. A second embodiment captures heat from hot black water (approximately 400° F.) as the high temperature water exits from a syngas quench cycle. A third embodiment utilizes a heat exchanger placed on the quench water return stream from the syngas scrubber that recycles the quench water at approximately 400° F. after being partially cleaned. Certain aspects of all three embodiments can be combined in a final process configuration to effectively use syngas cooling in one form or another to heat and dry incoming feedstocks. A fourth embodiment of the invention utilizes a modified form of the syngas cooling reflected in the first three embodiments.

Embodiments five through 9 of the invention concern exemplary syngas cooler designs used in the process according to the invention for heating a gas stream used to dry a solids feed to the gasifier, for example by employing continuous, vertically and/or horizontally aligned heating coils disposed at various positions in the syngas cooler. Embodiments 10 through 13 depict alternative embodiments of the process whereby a separate makeup gas stream similar to that used in the first, second and third embodiments is pre-heated using high temperature water before the gas is introduced into a grinding and drying mechanism (e.g., grinding mill or pulverizer) for the solids feedstock.

The invention exemplified by the above embodiments improves the efficiency of direct-fired coal systems in various ways. The makeup gas is directly heated as opposed to alternative prior art configurations which require, for example, steps to convert heat into steam and then transfer the heat from the steam to the makeup gas. By integrating the heating within the syngas cooler, the cost of a separate heat exchanger can be avoided.

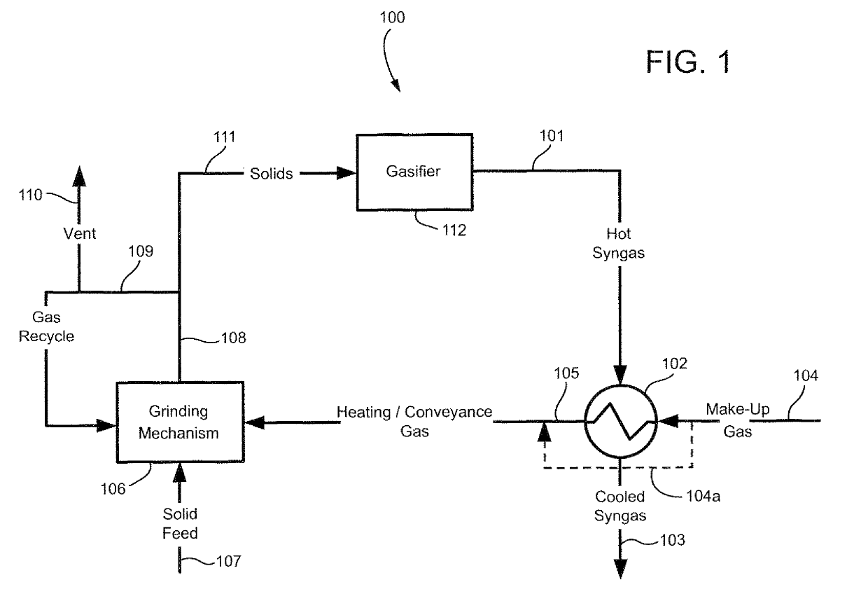

with particular reference to FIG. 1, an exemplary process flow diagram for a first embodiment of the invention using hot syngas as the principal medium to heat and dry the solids feedstock to the gasifier using a syngas cooler is shown generally at 100. In this first embodiment, gasification of the solid coal occurs in gasifier 110 to produce hot gases, particularly syngas stream 101 (typically in the range of about 2500° F.) which contains the results of incomplete coal combustion, including a significant fraction of unburned gaseous hydrocarbons and waste components such as residual acid compounds and sulfides.

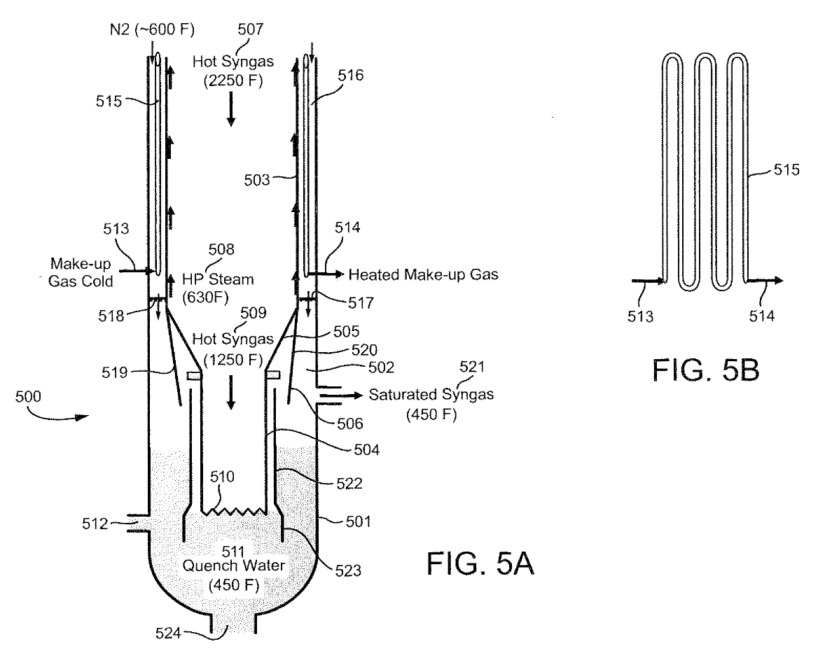

In operation, the hot syngas passes through syngas cooler 102, nominally with a shell and tube configuration of the type described below in connection with FIGS. 5 through 9 Makeup gas 104 comprising a combination of gases, i.e., nitrogen, oxygen and carbon dioxide, is fed through the tube side of syngas cooler 102 to produce a much dryer, high temperature heating/conveyance gas 105 that serves as the principal drying and gas conveyance means for the solid coal feedstock particulates produced using a conventional grinding mechanism 106.

FIG. 1 also shows an alternative flow configuration in dotted line format that includes bypass line 104a in which a portion of makeup gas stream 104 bypasses syngas cooler 102 and is then blended with heated gas from syngas cooler 102 in order to control the temperature of the gas feed to the grinding mill or other grinding mechanism 106. Solid coal feed 107 to the system is shown entering the bottom of grinding mechanism 106. The ground particulate feedstock entrained in the heating/conveyance gas being fed to the grinding mill 106 is then discharged as shown at 108 along with the water vapor removed from the solids particulates

Heating/conveyance gas 105 thus serves two principal functions, first to dry the pulverized fuel particulates that contain residual amounts of water, and second to provide the principal means for conveying the particulate solids through the grinding mill into the coal gasifier as shown. The cooled syngas 103 is shown on the shell side of syngas cooler 102.

In order to avoid an eventual accumulation of water in the system and to control the amount and size of entrained feedstock particulates fed to the gasifier, a certain amount of the entrained solids/vapor stream is recycled to the grinding mill, for example by passing the recycle stream 109 (two phase) through a cyclone separator (not shown) in order to drop out a majority of the entrained fines, and thereafter venting a portion of the vapor stream as shown at line 110 containing water vapor generated during the prior heating and pulverizing steps. The considerably drier, pulverized solids feedstock Ill (two-phase vapor and particulate) is then fed to gasifier 112.

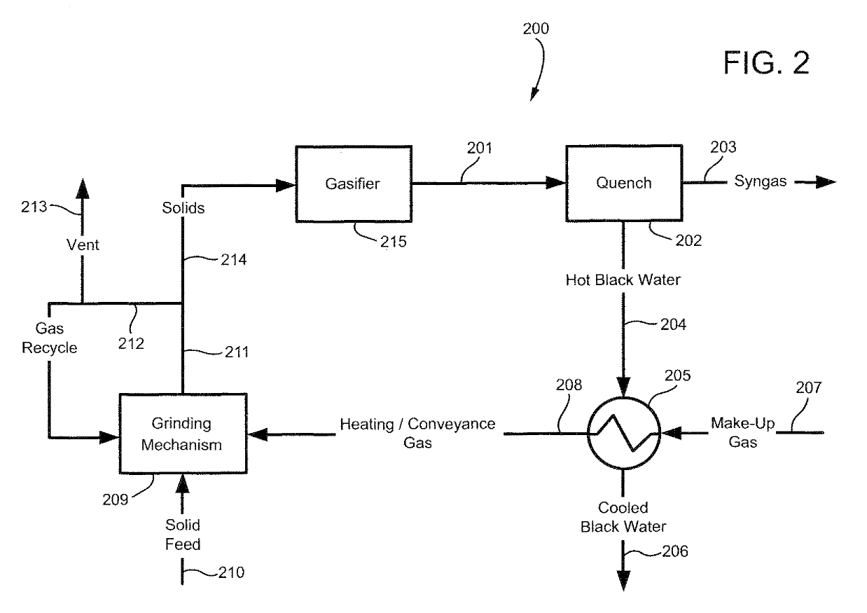

Referring now to FIG. 2, an exemplary process flow diagram of a second embodiment of the process according to the invention is depicted generally at 200, again using the heat removed from the hot syngas as the principal means to dry a solids feedstock. However, in this embodiment, the hot syngas produced by gasifier 215 (nominally at about 2500° F.) in exit stream 201 initially passes through a quench cycle 202 such as a gas-to-liquid heat exchanger which initially cools the syngas as shown leaving the quench cycle at 203.

The resulting hot liquid stream from the quench cycle at approximately 450° F. (labeled “hot black water”) 204 serves as the primary heating medium for recovering the residual syngas exhaust heat using syngas cooler 205. The cooled black water stream 206 typically is on the shell side of syngas cooler 205. The tube side includes makeup gas stream 207 consisting primarily of oxygen limited gas as described above which picks up a substantial amount of heat on the tube side to form hot “heating/conveyance” gas 208 for use in the grinding mill as generally described above in connection with the first embodiment.

As FIG. 2 also illustrates, the solids coal feed 210 to the grinding mill 209 loses a substantial fraction of entrained liquid (e.g., water vapor) during the grinding step after exiting grinding mill as shown at 211. This particular embodiment thus contemplates using a recycle stream 212 and vent arrangement as shown for the purpose of removing excess water vapor via vent line 213 as described in the first embodiment, with the clean and dried solids particulate stream 214 (again, two phase) being fed to gasifier 215 as the main solids fuel component.

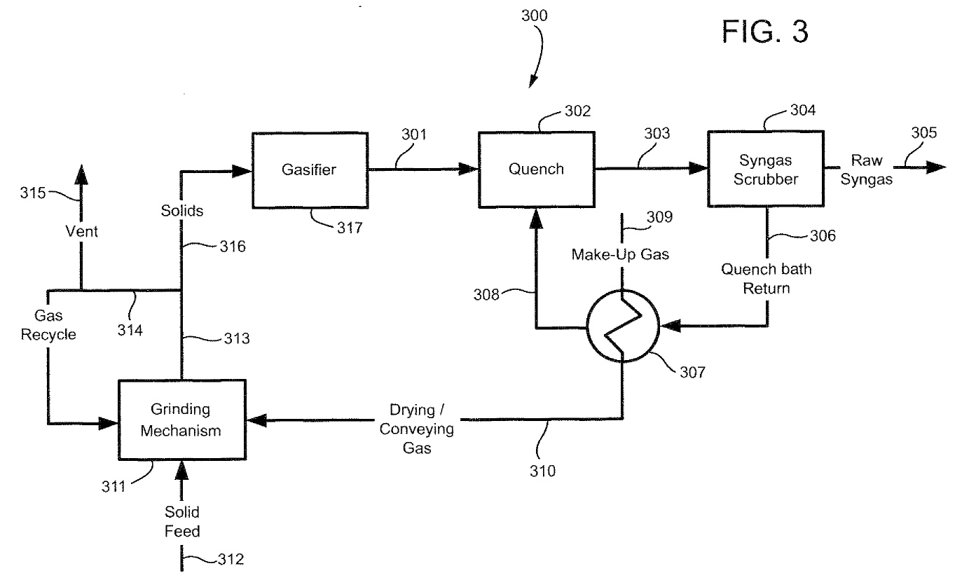

With respect to FIG. 3, an exemplary process flow diagram of a third embodiment of the process according to the invention using syngas cooling in a modification of the first two embodiments is depicted generally at 300. As in the second embodiment, the hot syngas 301 from the gasifier 317 initially undergoes a quench operation step 302, in this case dropping the syngas gas temperature from about 2500° F. at 303 down to about 500° F. The existing, initially cooled syngas then undergoes a scrubbing operation via syngas scrubber 304 (for example, a packed column) that removes unwanted components from the initial gas stream, with the treated vapor stream leaving the scrubber as cooled and treated “raw syngas” 305 at a temperature of about 500° F. In effect, the syngas scrubber depicted in FIG. 3 serves as a secondary quench.

The quench bath return 306 taken off the bottom of syngas scrubber 304 (typically at a temperature of about 400° F.) passes through syngas cooler 307, the primary purpose of which is to impart heat to gas makeup stream 309, and then used as the heated drying/conveyance gas feed 310 to grinding mechanism 311. FIG. 3 also shows cooled quench bath return 308. As in the first embodiment, the solid feed 312 to the grinding mechanism 311 comprises a coal feedstock containing a fixed amount of water that is carried with the ground coal particulates 313 must be removed (or at least substantially reduced) prior to being fed to gasifier 317.

Also similar to earlier embodiments, the heat recovery system depicted in the third embodiment recycles a certain amount of the entrained solids/vapor stream to the grinding mechanism (see recycle 314), for example by passing the two phase recycle through a cyclone separator to drop out the entrained particulates and venting a portion of the vapor stream as shown at 315 containing water vapor and fines generated during the prior heating and pulverizing steps. The considerably drier, vapor and particulate feedstock solids stream 316 is then fed to gasifier 317.

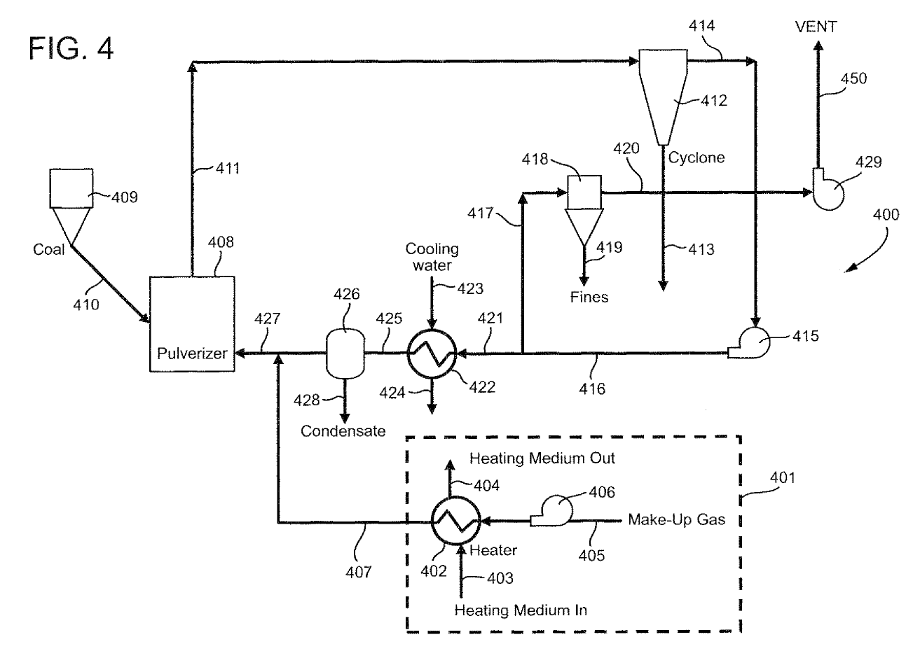

FIG. 4 is an exemplary process flow diagram of a fourth embodiment of the process according to the invention shown generally at 400, again using syngas cooling as described above in the first three embodiments as the primary source of the supplemental heating, drying and conveyance of solids coal feedstock to the gasifier. The syngas cooling subsystem in accordance with the invention is shown in a dotted line format as 401 and includes syngas cooler 402 with the hot syngas 403 (“heating medium in”) on the shell side exiting at 404 and makeup gas 405 having the composition described above (predominantly gases including nitrogen carbon dioxide, and oxygen) on the tube side of the syngas cooler. Nominally, the pressure of the makeup gas 405 is increased using compressor 406.

As in other embodiments, the heated makeup gas 407 leaving the syngas cooler serves as the principal drying/conveyance medium for the pulverized coal particulates generated through the grinding operation in grinding mill 408. The initial coal feed 410 from coal bin 409 also contains unwanted amounts of moisture that must be removed before being fed to the gasifier (not shown). Again, the resulting two-phase stream 411 leaving the grinding mill 408 includes dry coal particulates and a moist gas stream carrying the particulates into cyclone separator 412 which in turn separates the solids particulates out via bottom discharge line 413 from the moist recycle vapor 414. Typically, the solids materials at 413 are sent to the gasifier. The fine particles entrained in the 2-phase flow exiting the cyclone pass through a bag house containing dust filters which remove any residual fines 419. The fines are then fed as part of the solids feedstock to the gasifier.

As FIG. 4 also indicates, recycle stream 414 taken off the top of cyclone separator 412 contains water vapor that must be removed before being recycled. Thus, a fan (blower) 415 assists in transporting the combined water vapor and solids stream 416 through a condensor/heat exchanger 422 (with the input line shown as 421) having cooling water on the shell side with inlet 423 and outlet 424. The resulting cooled condensate stream 425 passes through condensate pot 426 resulting in a substantially dry vapor stream 427 that forms a part of the heated dry stream to the grinding mill as shown. The condensed water is thereafter removed as condensate via condensate line 428.

FIG. 4 also shows that a portion of stream 416 (return line 417) passes through a series of dust filters 418 (typically located inside a bag house) which remove additional coal feedstock fines 419, with the vapor stream 420 containing moisture vented to the atmosphere through vent line 450 using blower 429. As noted above, the combined work performed by syngas cooler 402 and the grinding mill 408 results in significantly better flow characteristics for the coal feedstock to the gasifier, as well as improved heat characteristics of the resulting gasification due to the inherent removal of water vapor during the process.

Turning now to FIG. 5A, an exemplary syngas cooler (heat exchanger) as used in the process according to the invention for heating the gas stream used to dry a solids feed to the gasifier is shown generally at 500, in this instance a syngas cooler having a continuous, vertically oriented coil 515 disposed in the annular space 516 between the outer cylindrical shell wall 501 and shell inner wall 503 (also referred to the tube cage outer wall). Together, the outer shell wall and wall disposed radially inward from the outer shell form a circumferential gap between the walls, in effect a “tube cage” or tube housing for the continuous vertically oriented heating coil 515. Heating coil 515 serves as the main element for transferring additional heat from the hot syngas 507 to the cold makeup gas 513 as described above in connection with FIGS. 1 through 4. Note heated makeup gas 514.

In operation, very hot syngas 507 from the initial gasifier combustion circuit at a temperature of about 2,250° F. passes down the inner cooler shell wall as shown into a quench chamber 511 in the syngas cooler containing high temperature (e.g., 450° F.) quench water under pressure at the bottom of the syngas cooler. Thus, the syngas in this embodiment undergoes two different heat exchange operations. First, the syngas transfers heat to the tube cage water wall 503. Heat is then transferred to the vertically oriented coil 515 disposed in the circumferential shell gap 516 described above. The coil is continuous in form with first and second entry ports, i.e., with cold makeup gas entering via line 513 as shown, traversing around the cooler in a plurality of continuous loops and exiting the cooler through line 514 at a significantly higher temperature. (See also FIG. 55).

In a second heat exchange operation, the hot syngas is cooled by virtue of the quench system which allows the syngas to be in direct contact with the quench water in quench chamber 511. That is, the hot gas flows down conical quench wall 505, inner cooler shell 504 and out the bottom opening 510 of the inner shell as shown. The resulting saturated syngas 521, now at a much cooler temperature of about 400-450° F., can be continuously removed from the cooler. FIG. 5A also shows that the makeup gas stream can include a portion of pre-hated nitrogen at a temperature of about 600° F. which can be combined with the cold makeup gas entering the system at 513 to increase the initial temperature. Other nominal structural features of syngas cooler 500 include seal assemblies 517 and 518 which divide the cooler into upper and lower portions thereof and isolate the vertically oriented makeup gas heating coil from the quench system and saturated syngas. Splash plates 519 and 520 contain and control the quench water below the saturated syngas exit 521 and below annular space 502.

FIG. 5A also depicts an exemplary configuration of the lower end 523 of dip tube 522 which remains below the quench water line during normal operation, with the quench water entry and exit points identified as 512 and 524 respectively. In the end, syngas cooler 500 produces high pressure steam 508 at about 630° F., thereby reducing the initial hot syngas down to a nominal temperature of about 1250° F. as shown at 509, while at the same time transferring valuable heat energy to the makeup gas stream using the auxiliary heating coil 515 described above.

FIG. 5B depicts the front elevation view of the continuous, vertically oriented coil disposed in the annular space between the water wall and vessel shell of the embodiment of FIG. 5A. Coil 515 comprises a continuous tube that carries makeup gas entering at 513, exiting at 514 and nominally configured as a continuous vertically-oriented series of loops that traverse the inner annular space between the inner and outer shells of syngas cooler 500 in FIG. 5A.

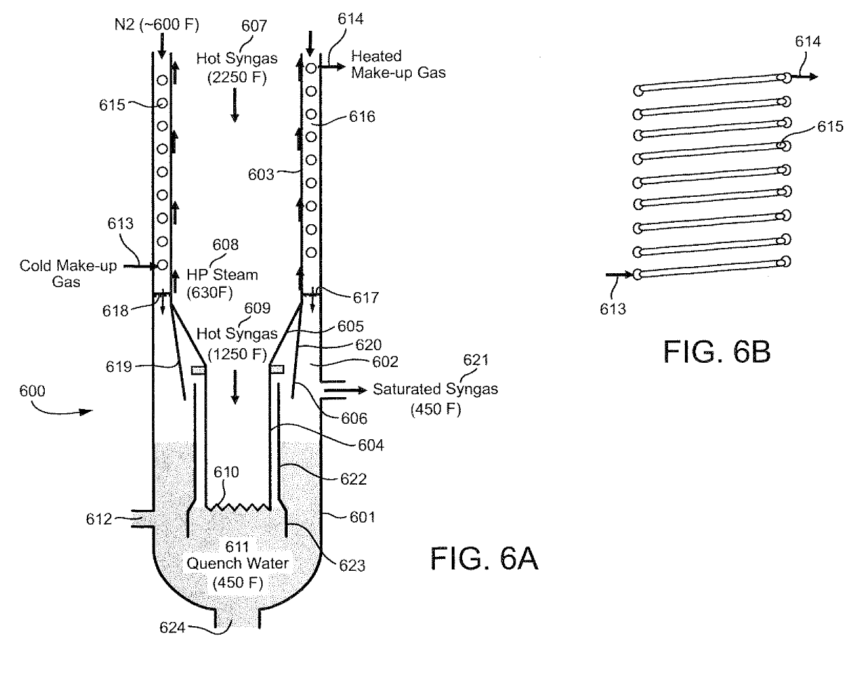

Turning to FIG. 6A, an alternative exemplary syngas cooler design forming part of the process according to the invention is shown generally at 600, in this case using a continuous horizontally oriented coil disposed in the annular space between the water wall and vessel shell. FIG. 6A depicts the same general configuration and operation of the syngas cooler described above in connection with FIG. 5A, but with the operative makeup gas heating coil 615 disposed in a different configuration as compared to the FIG. 5A embodiment, namely as a continuous, horizontally inclined loop with tube opening 613 and discharge 614 disposed in the annular space defined by inner vessel shell wall 603 and outer shell wall 601. For ease of reference, the other components of syngas cooler 600 are the same as those used in identifying like components in FIG. 5A but with corresponding 600 series numbers.

FIG. 6B provides a front elevation view of the continuous horizontally oriented coil disposed in the annular space between the water wall and vessel shell of the embodiment of FIG. 6A, again using 600 series item numbers for comparable components as depicted in FIG. 5B.

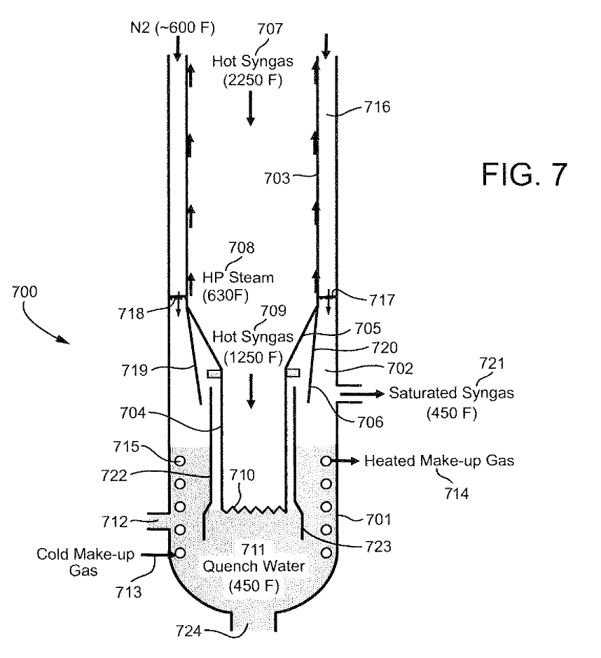

With respect to FIG. 7, another alternative exemplary syngas cooler design according to the invention is shown generally at 700, this time with the continuous horizontally oriented coil located in the lower portion of the syngas cooler shell containing high temperature quench water under pressure during normal operation. FIG. 7 depicts the same general configuration and operation of the syngas cooler described above in connection with FIGS. 5A and 6A, but with the operative makeup gas heating coil 615 disposed in a different configuration as compared to the FIG. 5A embodiment, namely as a continuous, horizontally inclined loop with tube opening 713 (cold makeup gas) and discharge 714 (heated makeup gas) submerged beneath the heated water disposed in quench chamber 711, rather than positioned in the annular space defined by inner and outer shell walls as depicted in the embodiments of FIGS. 5A and 6A. Again, for ease of reference the other major components of syngas cooler 700 are the same as those used in identifying like components in FIG. 5A, but with corresponding 700 series item numbers. The primary heat transfer coefficients in this embodiment will also be different, given the fact that conductive heat transfer occurs between the water in the quench chamber and the outside of the continuous loop 715.

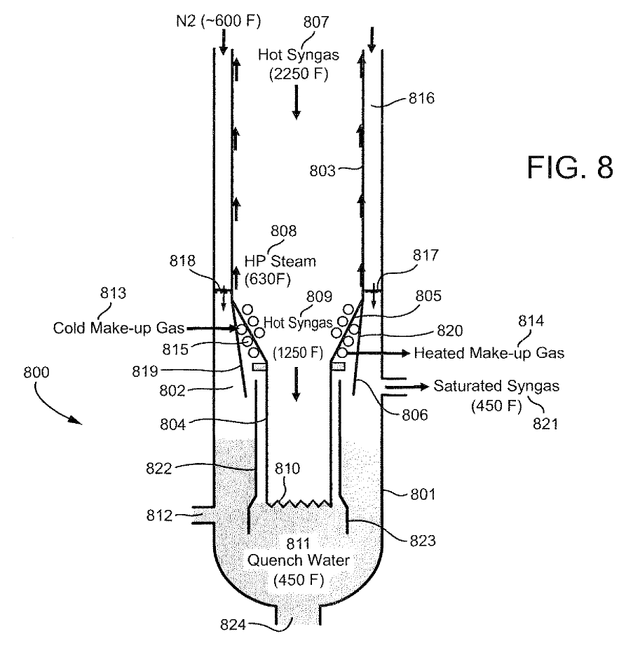

FIG. 8 shows a fourth alternative exemplary syngas cooler design as part of the process according to the invention shown generally at 800 using a continuous horizontally oriented makeup gas heating coil 815 disposed on opposite sides of the conical section of the quench wall located in the lower section of the cooler as described above. FIG. 8 depicts the same general configuration and operation of the syngas cooler described above in connection with FIG. 5A, but with the operative makeup gas heating coil 815 disposed in a different configuration as compared to the FIG. 5A embodiment, namely as a continuous, horizontally inclined loop with tube opening 813 and discharge 814 disposed on opposite sides of the conical section of quench wall 805 as shown. Again, for ease of reference, the other major components of syngas cooler 800 in this embodiment are the same as those used in identifying like components in FIG. 5A with corresponding 800 series item numbers.

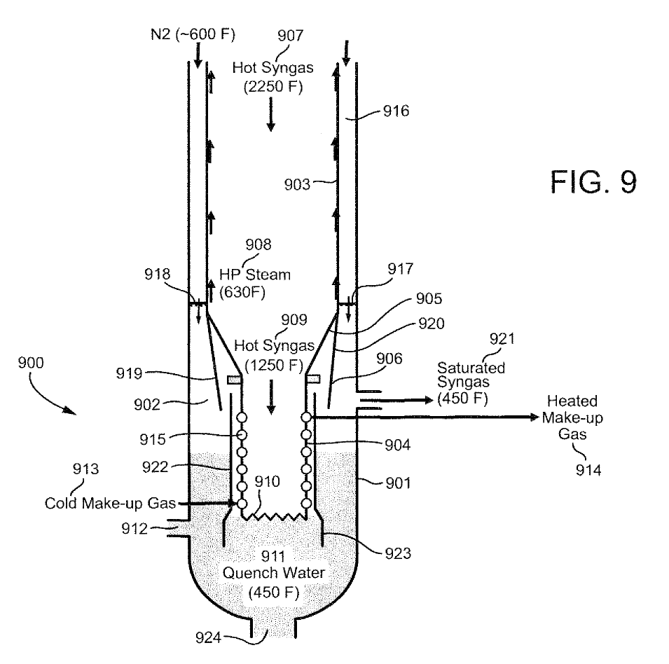

A fifth alternative exemplary syngas cooler design for use in the process according to the invention is shown in FIG. 9 at item 900. In this instance, a continuous, horizontally oriented coil disposed inside the inner cool shell wall (sometimes referred to as the cooler “dip tube” 904) is included. FIG. 9 thus depicts the same general configuration and operation of the syngas cooler described above in connection with FIG. 5A, but with the operative makeup gas heating coil 815 disposed in yet another configuration as compared to the FIG. 5A embodiment, namely as a continuous, horizontally inclined loop with makeup gas tube opening 913 and makeup gas discharge 914 both disposed on the inside of dip tube 904 as shown. Again, for ease of reference, the other major components of syngas cooler 900 in this embodiment are the same as those used in identifying like components in FIG. 5A with corresponding 900 series item numbers.

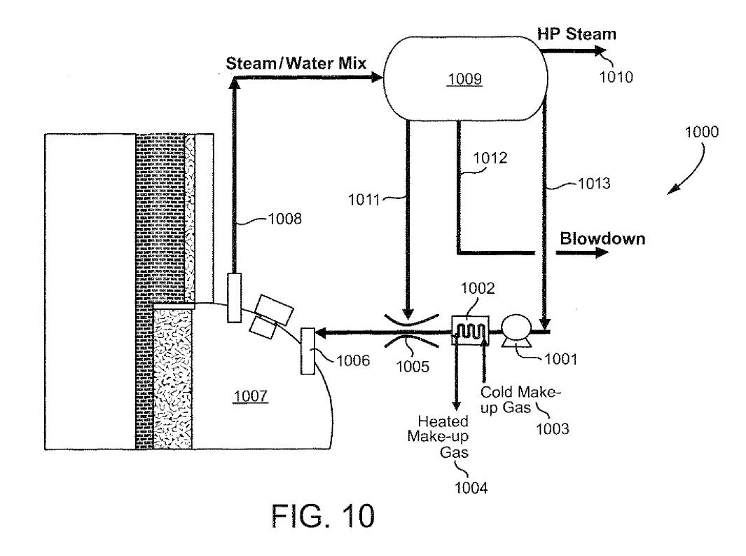

FIG. 10 depicts an exemplary process flow diagram of another embodiment of the process in which a separate, supplemental makeup gas stream for use in drying and heating coal feedstock is pre-heated using additional heat available from the syngas stream, but with high temperature water being used as the primary source of heat for the supplemental cold makeup gas. The syngas cooler in this embodiment is being used to impart additional heat to the makeup gas feed to the grinding mill or other grinding mechanism (in effect, “scavenging” additional heat available elsewhere in the system) using an in-place steam circuit and high pressure boiler feed water. The process results in an increase in the overall thermal efficiency of the gasification plant. After passing through syngas cooler 1007, an expanded steam/water mixture 1008 is returned to the high pressure steam drum 1009 to complete the steam circuit, with high pressure steam 1010 shown leaving the circuit for use downstream operations (such as a steam turbine). FIG. 10 also shows high temperature liquid blowdown 1012 (nominally at a temperature of about 630° F.) and high temperature feed 1013 to pump 1001.

The supplemental syngas cooler heating system reflected in embodiment 10 is shown generally at 1000, with a radiant syngas cooler 1007. In operation, supplemental cold makeup gas stream 1003 is fed through heat exchanger 1002 to pick up heat transferred from high pressure boiler feed water 1013 being fed to heat exchanger 1002 by centrifugal pump 1001. The resulting higher temperature makeup gas stream 1004 is then fed directly to the primary heated gas stream used to treat the coal feedstock in the grinding mechanism (e.g., grinding mill or pulverizer) as described above in connection with embodiments 1 through 4. The cooled boiler feed water downstream of heat exchanger 1002 passes through a venturi-like inductor 1005 to introduce an additional amount of high temperature water from high pressure steam drum 1009. The resulting mixed flow is fed into downcomer 1006 which introduces the water into the annular region of syngas cooler 1007.

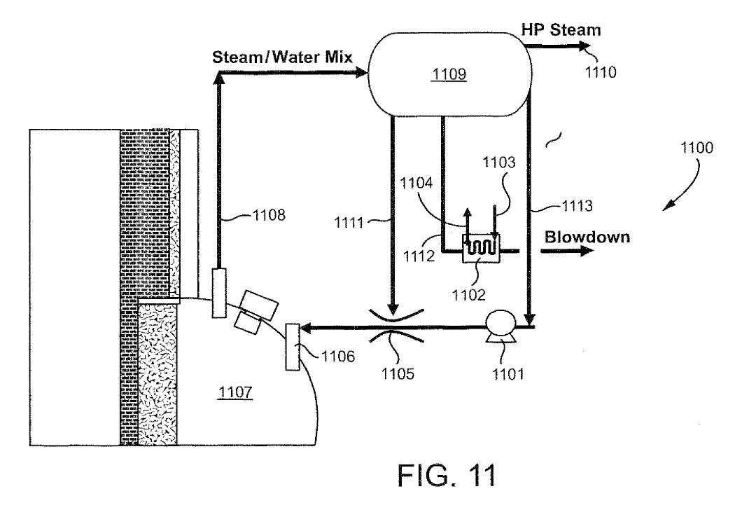

Turning to FIG. 11, an exemplary process flow diagram similar to FIG. 10 is shown generally at 1100, this time using a flow configuration for pre-heating the supplemental makeup gas stream using heat available from the syngas cooler and steam circuits before introducing makeup gas into the grinding mechanism. FIG. 10 thus depicts the same general configuration and operation of the supplemental makeup gas heating circuit using a syngas cooler described above in connection with FIG. 10, but with the heat transfer to the cold makeup gas using heat exchanger 1102 being provided by the liquid blowdown stream 1112, rather than by the high pressure liquid stream from the steam drum as noted in the previous embodiment. For ease of reference, the other major components of the syngas cooler circuit using this additional “scavenged” heat are the same as those used in identifying like components in FIG. 10 with corresponding 1100 series item numbers.

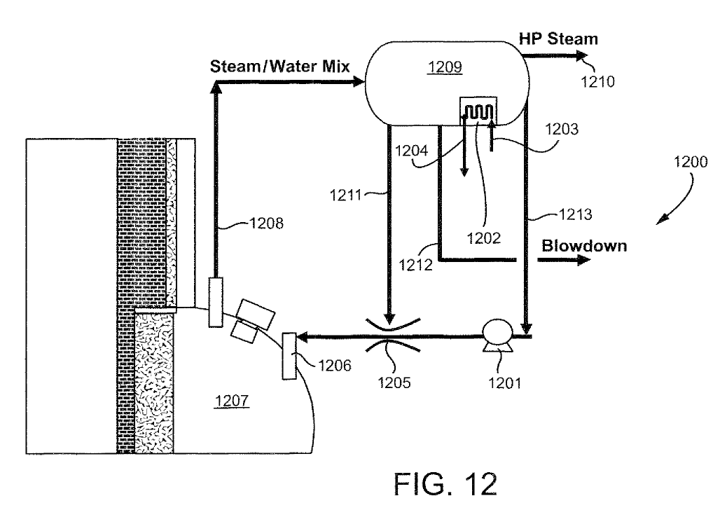

FIG. 12 shows an exemplary process flow diagram similar to FIG. 10 with a second alternative flow configuration for pre-heating the separate makeup gas before the gas is introduced into the grinding mechanism. The process is shown generally at 1200. In this embodiment, the additional scavenged heat is provided by positioning the supplemental makeup gas heat exchanger 1202 inside the high pressure steam drum 1209 itself, rather than using any direct connection to the high pressure steam drum liquid as the heating medium. Again, for ease of reference, the major components of the syngas cooler circuit using this additional scavenged syngas heat are the same as those in identifying like components in FIG. 10 with corresponding 1200 series item numbers.

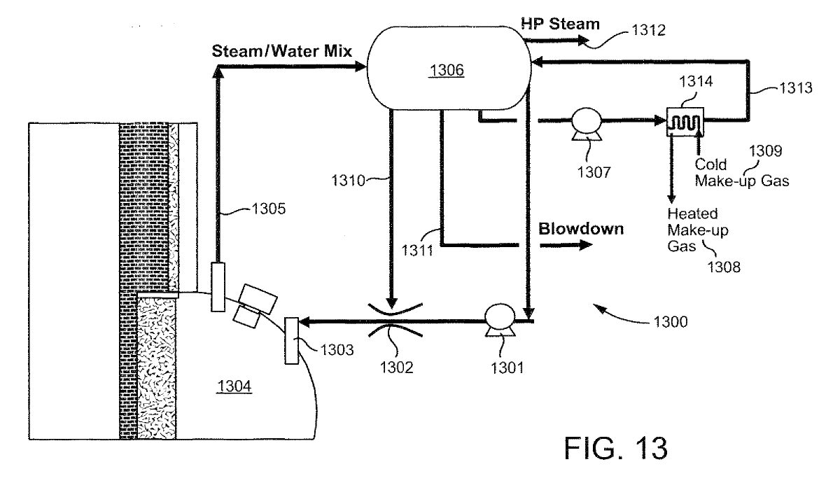

Finally, FIG. 13 depicts another exemplary process flow diagram similar to FIG. 10 but with a third flow configuration for pre-heating the supplemental makeup gas using syngas cooling before the gas is introduced into the grinding mechanism. The process is shown generally at 1300. Here, the auxiliary makeup gas heat exchange circuit uses high pressure steam drum water as the heating medium as part of a separate liquid circulation loop that includes centrifugal pump 1307. High pressure liquid return line 1313 on the downstream side of auxiliary heat exchanger 1314 is recycled to high pressure steam drum 1306. Again, for ease of reference the other major components of the syngas cooler circuit using additional scavenged syngas heat are the same as those used in identifying like components in FIG. 10 with corresponding 1300 series item numbers.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method for heating and drying a solid feedstock to a gasifier using syngas cooling, comprising the steps of:
transferring heat from a syngas exhaust stream of said gasifier to a makeup gas stream to form a high temperature makeup gas stream and cooled syngas;
simultaneously feeding a solid fuel component and a portion of said high temperature makeup gas stream into a grinding mechanism for said solid feedstock;
forming a two-phase solids/gas stream comprising ground feedstock particulates and said makeup gas stream;
simultaneously heating and drying said ground feedstock particulates to remove water and increase the temperature of said particulates;
separating and discharging water vapor formed in said heating and drying step from said two-phase solids/gas stream; and
feeding the heated and dried solids/gas stream to said gasifier.

2. A method according to claim 1, wherein said solid feedstock comprises sub-bituminous coal containing entrained water.

3. A method according to claim 1, wherein said step of transferring heat from said syngas exhaust stream occurs in a heat exchanger that transfers heat from said syngas exhaust stream at a temperature of about 2,250° F. to said makeup gas stream at about ambient temperature.

4. A method according to claim 3, wherein said makeup gas stream comprises oxygen limited gas that is heated to an exit temperature from said heat exchanger of about 600° F.

5. A method according to claim 1, further comprising the step of recycling a portion of said two-phase solids/gas stream containing ground feedstock particulates to a grinding mill used to form said particulates.

6. A system for heating and drying a solid coal feedstock to a gasifier using syngas cooling, comprising:
a first heat exchanger for transferring heat from a syngas exhaust stream downstream of said gasifier to a makeup gas stream;
a grinding mechanism capable of reducing the particle size of a solid fuel being fed to said gasifier and forming a two-phase solids/gas stream;
a heated gas stream having sufficient heat value to vaporize water adsorbed on particulates entrained in said two-phase solids/gas stream;
a second heat exchanger for condensing and removing substantially all of the vaporized water in said two-phase solids/gas stream; and
transport means sized to move said two-phase solids/gas stream into said gasifier.

7. A system for heating and drying a solid coal feedstock according to claim 6, wherein said first heat exchanger produces a high temperature makeup gas stream and cooled syngas exhaust stream.

8. A system for heating and drying a solid coal feedstock according to claim 6, wherein said heating means results in a two-phase solids/gas stream comprising ground coal particulates entrained in a portion of said makeup gas stream.

9. A system for heating and drying a solid coal feedstock according to claim 6, wherein said makeup gas stream comprises an oxygen limited gas.

10. A system for heating and drying a solid coal feedstock according to claim 6, further comprising a third heat exchanger for transferring heat from boiler feed water to said makeup gas stream prior to feeding said makeup gas stream to said grinding mechanism.

11. A system for heating and drying a solid coal feedstock according to claim 6, further comprising a third heat exchanger for transferring heat from a liquid blowdown stream to said makeup gas prior to feeding said makeup gas to said grinding mechanism.

12. A syngas cooler for transferring heat from a syngas exhaust stream to a makeup gas stream in a power generation plant, comprising:
a pressure vessel having an outer cylindrical shell and inner cylindrical shell disposed radially inward from said outer shell to define a circumferential gap therebetween;
a ring seal assembly disposed at one end of said gap and coupled to said inner and out shell walls to separate said circumferential gap into upper and lower portions thereof;
a first heat exchange element disposed within said circumferential gap for transporting said makeup gas through said syngas cooler;
entry and exit ports for said makeup gas stream coupled to said first heat exchange element and to said outer shell wall in the upper portion thereof;
a second heat exchange element disposed radially inward from said gap and said inner shell for transporting high temperature syngas down the interior of said syngas cooler;
entry and exit ports for said high temperature syngas coupled to said outer shell wall in the lower portion thereof; and
a quench tube positioned toward the bottom of said syngas cooler

13. A syngas cooler according to claim 12, wherein heat from said syngas is transmitted through said inner shell wall to said first heat exchange element to increase the temperature of said makeup gas stream.

14. A syngas cooler according to claim 12, wherein said first heat exchange element comprises a continuous, vertically oriented tubing coil disposed within said gap for carrying said makeup gas.

15. A syngas cooler according to claim 12, wherein said first heat exchange element comprises a continuous, horizontally oriented tubing coil disposed within said gap for carrying said makeup gas stream.

16. A syngas cooler according to claim 12, wherein said first heat exchange element comprises a continuous, vertically oriented tubing coil submerged below the level of quench water in the lower portion of said syngas cooler.
